(19) United States
(12) Patent Application Publication
(10) Pub. No.: US 2013/0280556 A1
(43) Pub. Date: Oct. 24, 2013

(54) MAGNETIC RECORDING MEDIA WITH SOFT MAGNETIC UNDERLAYERS

(71) Applicant: SEAGATE TECHNOLOGY LLC, Cupertino, CA (US)

(72) Inventors: Li Tang, Fremont, CA (US); Weilu Xu, San Jose, CA (US); Youfeng Zheng, San Jose, CA (US); Shanghsien Rou, Fremont, CA (US); Connie Chunling Liu, San Jose, CA (US); Jianhua Xue, Maple Grove, MN (US); Li-Lien Lee, San Jose, CA (US); Thomas P. Nolan, Fremont, CA (US)

(21) Appl. No.: 13/919,983

(22) Filed: Jun. 17, 2013

Related U.S. Application Data
(63) Continuation-in-part of application No. 11/606,998, filed on Dec. 1, 2006, now Pat. No. 8,465,854.

(51) Int. Cl. G11B 5/31; G11B 5/127

(52) U.S. Cl. CPC G11B 5/3153; G11B 5/1278; G11B 5/1276
USPC 428/812; 428/827; 428/828.1

(57) ABSTRACT

Provided herein, is an apparatus that includes a nonmagnetic substrate having a surface; and a plurality of overlying thin film layers forming a layer stack on the substrate surface. The layer stack includes a magnetically hard perpendicular magnetic recording layer structure and an underlying soft magnetic underlayer (SUL), wherein the sum of a magnetic thickness of the layer stack is a magnetic thickness of up to about 2 memu/cm̂2.

### CROSS-REFERENCE

This application is a continuation-in-part of co-pending U.S. patent application Ser. No. 11/606,998, filed 1 Dec. 2006.

### BACKGROUND

Magnetic media are widely used in various applications, particularly in the computer industry for data/information storage and retrieval applications, typically in disk form, and efforts are continually made with the aim of increasing the areal recording density, i.e., bit density of the magnetic media. Conventional thin-film type magnetic media, wherein a fine-grained polycrystalline magnetic alloy layer serves as the active recording layer, are generally classified as “longitudinal” or “perpendicular”, depending upon the orientation of the magnetic domains of the grains of magnetic material.

In perpendicular magnetic recording media, residual magnetization is formed in a direction (“easy axis”) perpendicular to the surface of the magnetic medium, typically a layer of a magnetic material on a suitable substrate. Very high to ultra-high linear recording densities are obtainable by utilizing a “single-pole” magnetic transducer or “head” with such perpendicular magnetic media.

### SUMMARY

Provided herein, is an apparatus that includes a nonmagnetic substrate having a surface; and a plurality of overlying thin film layers forming a layer stack on the substrate surface. The layer stack includes a magnetically hard perpendicular magnetic recording layer structure and an underlying soft magnetic underlayer (SUL), wherein the sum of a magnetic thickness of the layer stack is a magnetic thickness of up to about 2 memu/cm̂2.

These and other features and advantages will be apparent from a reading of the following detailed description.

### DRAWINGS

Various embodiments are illustrated by way of example, and not by way of limitation, in the figures of the accompanying drawings and in which like reference numerals refer to similar elements.

FIG. 1 illustrates a cross sectional view of a magnetic recording, storage, and retrieval system according to one aspect of the present embodiments.

FIG. 2 illustrates a cross sectional view of a magnetic recording, storage, and retrieval system according to one aspect of the present embodiments.

FIG. 3 illustrates the recording performance of perpendicular magnetic recording media according to one aspect of the present embodiments.

FIG. 4 illustrates a CGC-structured multilayer recording layer, as a function of SUL thickness according to one aspect of the present embodiments.

FIGS. 5A and 5B illustrates variations of numerically simulated head field conforming footprints of perpendicular media according to one aspect of the present embodiments.

### DESCRIPTION

Before various embodiments are described in greater detail, it should be understood that the embodiments are not limited to the particular embodiments described and/or illustrated herein, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein.

It should also be understood that the terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps, and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. It should also be understood that, unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” and the like are used for convenience and are not intended to imply, for example, any particular fixed location, orientation, or direction. Instead, such labels are used to reflect, for example, relative location, orientation, or directions. It should also be understood that the singular forms of “a,” “an,” and “the” include plural references unless the context clearly dictates otherwise.

An apparatus is described herein for embodiments of a perpendicular media with a thin SUL. The features of the disclosed embodiments are based upon recognition that perpendicular media with thin SUL's, exhibiting good writability, can be achieved by appropriate selection of the structure, composition, and thickness of the magnetically hard recording layer structure. In addition, the performance of magnetic recording systems comprising perpendicular media with thin SUL's is materially improved by use of single pole write heads equipped with front shields adjacent the main pole thereof, thereby enhancing the perpendicular field component and controlling the field angle, hence enhancing the effective write field for providing optimal recording performance.

The various embodiments will now be described in greater detail.

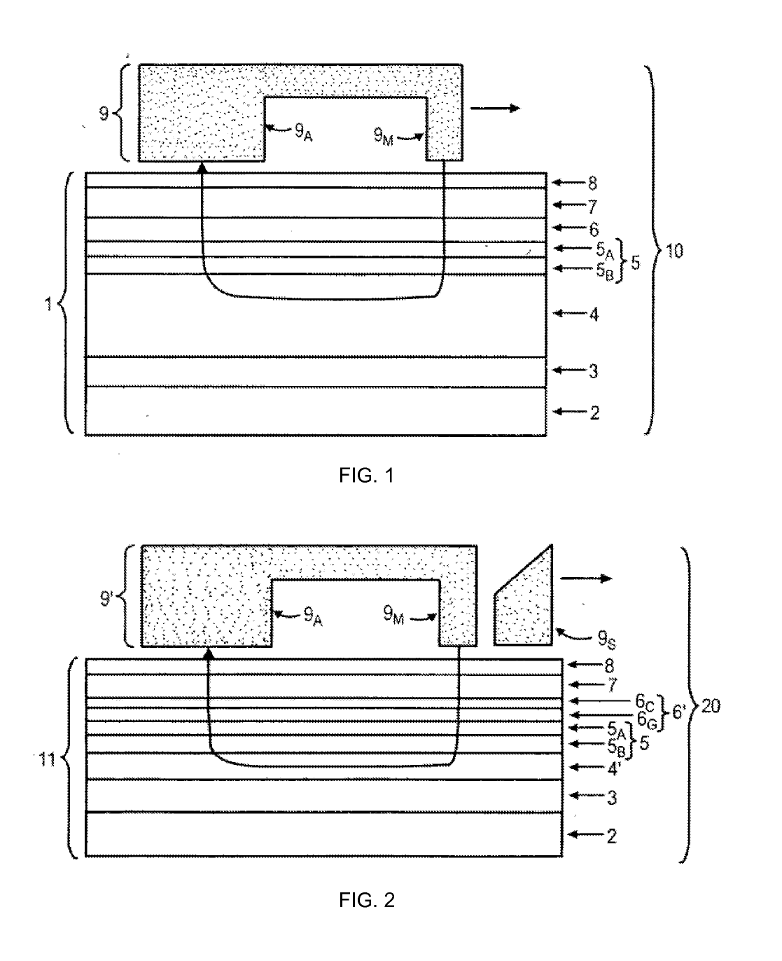

A perpendicular recording system 10 with a perpendicularly oriented magnetic medium 1 and a magnetic transducer head 9 is schematically illustrated in FIG. 1, wherein reference numeral 2 indicates a non-magnetic substrate, reference numeral 3 indicates an optional adhesion layer, reference numeral 4 indicates a relatively thick magnetically soft underlayer (SUL), reference numeral 5 indicates an interlayer stack comprising a non-magnetic interlayer, sometimes referred to as an “intermediate” layer, and reference numeral 6 indicates a relatively thin magnetically hard perpendicular recording layer with its magnetic easy axis perpendicular to the film plane. Interlayer stack 5 commonly includes an interlayer 5_{B} of an hcp material adjacent the magnetically hard perpendicular recording layer 6 and an optional seed layer 5_{A} adjacent the magnetically soft underlayer (SUL) 4, typically comprising an amorphous material and an fcc material.

Furthermore, according to an embodiment, reference numerals 9_{M} and 9_{A}, respectively, indicate the main (writing) and auxiliary poles of the magnetic transducer head 9. The relatively thin interlayer 5, comprised of one or more layers of non-magnetic materials, serves to (1) prevent magnetic interaction between the magnetically soft underlayer 4 and the magnetically hard recording layer 6; and (2) promote desired microstructural and magnetic properties of the magnetically hard recording layer 6.

As shown by the arrows in the figure indicating the path of the magnetic flux φ, flux φ emanates from the main writing pole 9_{M} of magnetic transducer head 9, enters and passes through the vertically oriented, magnetically hard recording layer 6 in the region below main pole 9_{M}, enters and travels within soft magnetic underlayer (SUL) 4 for a distance, and then exits therefrom and passes through the perpendicular hard magnetic recording layer 6 in the region below auxiliary pole 9_{A} of transducer head 9. The relative direction of movement of perpendicular magnetic medium 21 past transducer head 9 is indicated in the figure by the arrow in the figure.

Completing the layer stack of medium 1 is a protective overcoat layer 7, such as of a diamond-like carbon (DLC), formed over magnetically hard layer 6, and a lubricant topcoat layer 8, such as of a perfluoropolyether (PFPE) material, formed over protective overcoat layer 7.

According to an embodiment, FIG. 2 illustrates a portion of a magnetic recording, storage, and retrieval system 20 comprised of a perpendicular magnetic recording medium 11 structured for use with a modified magnetic transducer head 9′. Medium 11 generally resembles the perpendicular medium 1 of FIG. 1, and comprises a series of thin film layers arranged in an overlying (i.e., stacked) sequence on a non-magnetic substrate 2 comprised of a non-magnetic material selected from the group consisting of: Al, Al—Mg alloys, other Al-based alloys, NiP-plated Al or Al-based alloys, glass, ceramics, glass-ceramics, polymeric materials, and composites or laminates of these materials.

The thickness of substrate 2 is not critical; however, in the case of magnetic recording media for use in hard disk applications, substrate 2 must be of a thickness sufficient to provide the necessary rigidity. Substrate 2 typically comprises Al or an Al-based alloy, e.g., an Al—Mg alloy, or glass or glass-ceramics, and, in the case of Al-based substrates, includes a plating layer, typically of NiP, on the surface of substrate 2 (not shown in the figure for illustrative simplicity). An optional adhesion layer 3, typically a less than about 100 Å thick layer of an amorphous metallic material or a fine-grained material, such as a metal or a metal alloy material, e.g., Ti, a Ti-based alloy, Ta, a Ta-based alloy, Cr, or a Cr-based alloy, may be formed over the surface of substrate 2 or the NiP plating layer thereon.

Overlying substrate 2 or optional adhesion layer 3 is a thin magnetically soft underlayer (SUL) 4′ formed according to an embodiment. According to embodiments, the SUL 4′ is substantially thinner than a conventional SUL and comprises a layer of a magnetically soft material up to about 100 Å thick, selected from the group consisting of: Co, Fe, an Fe-containing alloy such as NiFe (Permalloy), FeN, FeSiAl, FeSiAlN, a Co-containing alloy such as CoZr, CoZrCr, CoZrNb, or a Co—Fe-containing alloy such as CoFeZrNb, CoFe, FeCoB, and FeCoC.

As in medium 1, an optional adhesion layer 3 may be included in the layer stack of medium 11 between the surface of substrate surface 2 and the SUL 4′, the adhesion layer 3 being less than about 200 Å thick and comprised of a metal or a metal alloy material such as Ti, a Ti-based alloy, Ta, a Ta-based alloy, Cr, or a Cr-based alloy.

Furthermore, in FIG. 2, the layer stack of medium 11 further comprises a non-magnetic interlayer stack S between SUL 4′ and overlying multilayer perpendicular magnetic recording structure 6′ and is comprised of nonmagnetic material(s). For example, interlayer stack 5 may typically include at least one interlayer 5_{A} adjacent the multilayer perpendicular magnetic recording structure 6′, comprising a layer of a hcp material from about 5 to about 50 nm thick, such as Ru, TiCr, Ru/CoCr₃₇Pt₆ RuCr/CoCrPt, or RuX, where X is at least one of B and Cr. When present, seed layer 5_{B} adjacent the magnetically soft underlayer (SUL) 4′ may typically include a less than about 100 Å thick layer of an fcc material, such as an alloy of Cu, Ag, Pt, or Au, or an amorphous or fine-grained material, such as Ta, TaW, CrTa, Ti, TiN, TiW, or TiCr.

According to an embodiment, the multilayer perpendicular magnetic recording structure 6′ is, for example, comprised of a granular perpendicular magnetic recording layer 6_{G} adjacent interlayer 5_{A} and an overlying continuous perpendicular magnetic recording layer 6_{C}. The resultant multilayer structure 6′, termed a “coupled granular-continuous”, or “CGC” structure, exhibits high areal recording densities with enhanced magnetic performance characteristics. According to such multilayer stacked CGC structure, the granular perpendicular recording layer, wherein the magnetic grains are only weakly exchange coupled together, and the continuous perpendicular recording layer, wherein the magnetic grains are strongly exchange coupled laterally, are ferromagnetically coupled together.

Typically, the granular perpendicular magnetic recording layer 6_{G} is from about 5 to about 30 nm thick and comprised of a Co-based alloy wherein segregation of magnetic grains occurs via formation of oxides, nitrides, or carbides at the boundaries between adjacent grains. The oxides, nitrides, or carbides may be formed by introducing a minor amount of at least one reactive gas, e.g., oxygen (O₂), nitrogen (N₂), or a carbon (C)-containing gas to the inert gas (e.g., Ar) atmosphere during deposition (e.g., sputter deposition) thereof. For example, the granular perpendicular magnetic recording layer 6_{G} may be comprised of a CoCrPt—X material, wherein X is selected from the group consisting of oxides, nitrides, and carbides, e.g., CoCrPt—SiO₂, CoCrPt—SiNx, and CoCrPt—SiC.

Typically, the continuous perpendicular magnetic recording layer 6_{C} is from about 2 to about 15 nm thick and comprised of one or more layers of a Co-based alloy, e.g., a CoCrPtX alloy, where X may be selected from the group consisting of: Pt, Fe, Tb, Ta, B, C, Mo, V, Nb, W, Zr, Re, Ru, Ag, Hf, Ir, Si, and Y. Preferably, the perpendicular magnetic recording layer 6_{C} comprises a fine-grained hcp alloy with a preferred c-axis perpendicular growth orientation.

Finally, the layer stack of medium 11 includes a protective overcoat layer 7 above the multilayer perpendicular magnetic recording structure 6′ and a lubricant topcoat layer 8 over the protective overcoat layer 7. Preferably, the protective overcoat layer 7 comprises a carbon-based material, e.g., diamond-like carbon (“DLC”), and the lubricant topcoat layer 8 comprises a fluoropolymer material, e.g., a perfluoropolyether compound.

According to an embodiment, each of the layers 3, 4′, 5, 6′, 7 may be deposited or otherwise formed by techniques typically utilized for formation of thin film layers, e.g., physical vapor deposition (“PVD”) techniques, including but not limited to, sputtering, vacuum evaporation, ion plating, cathodic arc deposition (“CAD”), etc., or by any combination of various PVD techniques. The lubricant topcoat layer 8 may be provided over the upper surface of the protective overcoat layer 7 in any convenient manner, e.g., as by dipping the thus-formed medium into a liquid bath containing a solution of the lubricant compound.

Moreover, FIG. 2 illustrates a magnetic data/information recording, storage, and retrieval system 20 which includes a modified transducer head 9′ positioned in close proximity to the upper surface of medium 11, i.e., the upper surface of lubricant topcoat layer 8, and includes a front shield 9_{S} adjacent the main pole 9_{M}. As indicated above, single pole write heads equipped with front shields adjacent the main pole thereof exhibit an enhanced perpendicular field component and controlled field angle, thereby having an enhanced effective write field for providing optimal recording performance.

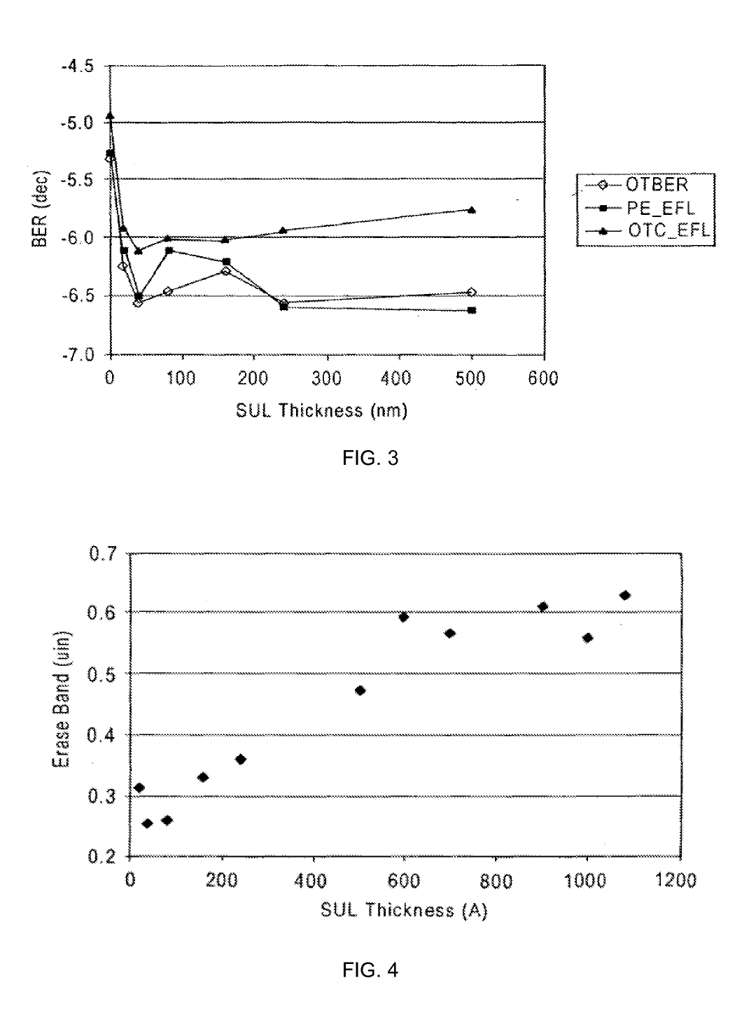

According to an embodiment, FIG. 3 illustrates a graph wherein the recording performance of perpendicular magnetic recording media comprising a CGC-structured multilayer recording layer, as a function of SUL thickness, wherein: “BER”=bit error rate; “OTBER”=on-track bit error rate of a data track on an AC erased background; “PE_EFL”=on-track bit error rate of a data track written on a background of pre-written data; and “OTC_EFL”=on-track bit error rate of a data track written on a background of pre-written data and with adjacent written tracks.

In FIG. 3, the perpendicular media with thin SUL's may exhibit better or at least comparable performance, at 1168 kbpi when compared with other perpendicular media with thick SUL's. Thus, in the SUL thickness range up to about 500 Å, an optimal OTC BER's have been obtained at SUL thicknesses as low as about 40 Å, i.e., significantly thinner than the 500 Å thickness of SUL's of currently available perpendicular media. This result also indicates that the thin SUL's according to an embodiment enlarge the field angle and improve the effective writing field.

FIG. 4 illustrates a graph wherein the dependence of erase band width of perpendicular magnetic recording media, comprising a CGC-structured multilayer recording layer, is a function of SUL thickness. As further illustrated in FIG. 4, the perpendicular media with thin SUL's (i.e., ˜100 Å or less) exhibit erase band widths which are at least 50% narrower than those of currently available perpendicular media with thicker SUL's. Potential advantages of the narrower erase band widths afforded by the thin SUL media are increased media tpi capability and greater tolerance of larger write pole widths.

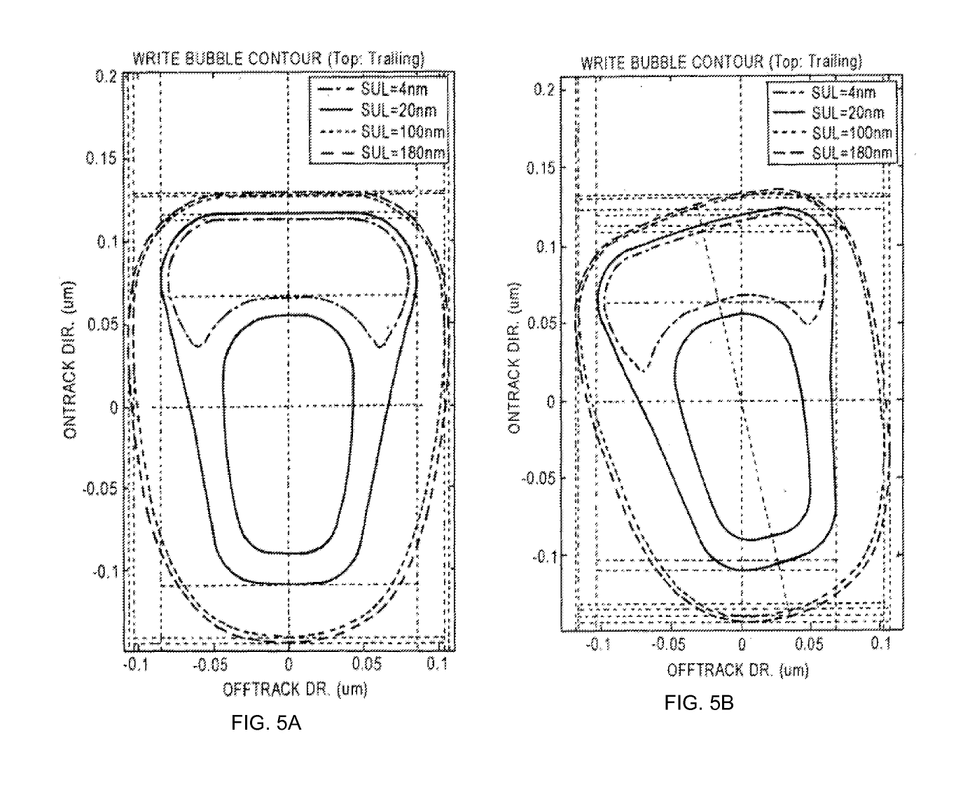

According to an embodiment, FIGS. 5A and 5B illustrates, variations of numerically simulated head field conforming footprints of perpendicular media as a function of SUL thickness, at skew angles of 0° and 14°, respectively. Such simulations indicate that for perpendicular media with thin SUL's, according to an embodiment, have much smaller head field conforming footprints than conventional thick SULs perpendicular media in both the down-track and cross-track directions. The trailing edge transition curvature of the thin SUL media is less in the cross-track direction and the magnetic wall angle is larger, compared to the thick SUL media. Therefore, the perpendicular media with thin SUL's are advantageously more tolerant to large head skew angles and more likely to be written with straight transitions.

Additional advantages afforded by the thin SUL perpendicular recording media, according to an embodiment, include increased flexibility m accommodating different write head designs and clearance specifications by varying the SUL thickness as to optimize the effective field strength and angle for achieving improved recording performance, relative to the currently available thick SUL media.

The effectiveness of an SUL as a guide for magnetic flux is determined primarily by its magnetic thickness (Bs*t) and its permeability (p). Bs is the saturation magnetic moment of the material and t is the thickness of the SUL layer. Permeability is the ability to carry magnetic current or flux, much like an electrical conductivity, and is given by B/H, where H is the applied field.

In SUL designs, the focus has been on materials having very high permeability >˜100, and the highest possible Bs (often ˜1.5-2.0 Tesla) consistent with manufacturing and film growth requirements because designs called for as thick of an SUL as was reasonable possible to manufacture. In this regime, the flux guiding capability was primarily defined by the SUL film thickness. With this paradigm, it is natural and convenient to describe relative SUL flux guiding capability in terms of a simple layer thickness (e.g., physical thickness). According to an embodiment, a physical thickness of an SUL may be approximately 100 A. This thickness may describe an SUL with, for example, 20 times less flux guiding capacity than a more conventional 2000 A SUL.

Therefore, as design implementations are reduced from, for example, a 2000 A SUL to, for example, a 100 A SUL with 20 times less flux carrying capacity the SUL is optimized and many of the manufacturing limitations on thickness are reduced and/or removed. Furthermore, the requirements to maximize Bs (e.g., permeability) of the material, so other materials issues relating to film growth, corrosion resistance, substrate heating, and/or particle generation, is no longer required and can be optimized along with reducing Bs of the SUL material. Thus, the permeability is correspondingly reduced as it is proportional to Bs. Moreover, the flux carrying/guiding capability of the materials that continue to be designed to optimally perform the limited flux guiding function of a high Bs, <100 A SUL are optimized on a per/Angstrom basis.

Thus, according to another embodiment, a flux guiding capacity may be defined by a magnetic thickness (Bs*t) even in the case of the physical thickness. Therefore, the flux carrying capacity of a 400 A thick layer of an SUL material having a Bs=0.5t exhibits a similar thickness, or an even lower thickness, than, for example, a 100 A SUL having a Bs approximately 2.0t. Therefore, the sum of a magnetic thickness of the layer stack may be represented as a magnetic thickness of up to about 2 memu/cm̂2.

Thus, performance, high areal density, magnetic alloy-based perpendicular magnetic media and data/information recording, storage, and retrieval systems, which media include very thin soft magnetic underlayers (SUL's) exhibit improved performance characteristics when utilized in combination with single pole magnetic transducer heads. The media enjoys particular utility in high recording density systems for computer-related applications. In addition, the inventive media can be fabricated by means of media manufacturing technologies, e.g., sputtering.

While embodiments have been described and/or illustrated by means of examples, and while these embodiments and/or examples have been described in considerable detail, it is not the intention of the applicant(s) to restrict or in any way limit the scope of the embodiments to such detail. Additional adaptations and/or modifications of the embodiments may readily appear in light of the described embodiments, and, in its broader aspects, the embodiments may encompass these adaptations and/or modifications. Accordingly, departures may be made from the foregoing embodiments and/or examples without departing from the scope of the embodiments. The implementations described above and other implementations are within the scope of the following claims.

What is claimed is:

1. An apparatus comprising:
a non-magnetic substrate having a surface; and
a plurality of overlying thin film layers forming a layer stack on the substrate surface, the layer stack including a magnetically hard perpendicular magnetic recording layer structure and an underlying soft magnetic underlayer (SUL), wherein:
the sum of a magnetic thickness of the layer stack is a magnetic thickness of up to about 2 memu/cm̂2.

2. The apparatus of claim 1, wherein:
the magnetically hard perpendicular magnetic recording layer structure comprises a multilayer structure.

3. The apparatus of claim 2, wherein:
the multilayer structure comprises a granular perpendicular magnetic recording layer wherein the magnetic grains are only weakly exchange coupled together, and an overlying continuous perpendicular magnetic recording layer wherein the magnetic grains are strongly exchange coupled laterally together.

4. The apparatus of claim 3, wherein:
the granular perpendicular magnetic recording layer and the continuous perpendicular magnetic recording layer are ferromagnetically coupled together to form a coupled granular-continuous (CGC) structure.

5. The apparatus of claim 3, wherein:
the granular perpendicular magnetic recording layer is from about 5 to about 30 nm thick and comprised of a Co-based alloy wherein segregation of magnetic grains occurs via formation of oxides, nitrides, or carbides at the boundaries between adjacent grains.

6. The apparatus of claim 3, wherein:
the continuous perpendicular magnetic recording layer is from about 2 to about 15 nm thick and comprised of one or more layers of a Co-based alloy.

7. The apparatus of claim 3, wherein:
the layer stack further comprises at least one interlayer between said multilayer perpendicular magnetic recording structure and said SUL.

8. The apparatus of claim 7, wherein:
the at least one interlayer comprises a Ru-containing material.

9. The apparatus of claim 8, wherein:
the Ru-containing material comprises RuX, where X is B or Cr.

10. The apparatus of claim 1, further comprising:
a single-pole magnetic transducer head including a main and an auxiliary pole positioned in space adjacent to an upper surface of said layer stack, wherein the single-pole transducer head includes a front shield adjacent the main pole.

11. An apparatus, comprising:
a non-magnetic substrate having a surface; and
a plurality of overlying thin film layers forming a layer stack on the substrate surface, the layer stack including a magnetically hard perpendicular hard perpendicular magnetic recording layer structure and an underlying soft magnetic underlayer (SUL), wherein:
the sum of a magnetic thickness of the layer stack is a magnetic thickness of up to about 2 memu/cm̂2, and
the magnetically hard perpendicular magnetic recording layer structure comprises a granular perpendicular magnetic recording layer, wherein the magnetic grains are exchange coupled together, and
an overlying continuous perpendicular magnetic recording layer, wherein the magnetic grains are exchange coupled laterally together, and
the magnetic grains in the continuous perpendicular layer are more strongly exchange coupled than the magnetic grains in the granular perpendicular magnetic recording layer.

12. The apparatus of claim 11, wherein:
the granular perpendicular magnetic recording layer and the continuous perpendicular magnetic recording layer are ferromagnetically coupled together to form a coupled granular-continuous (CGC) structure.

13. The apparatus of claim 11, wherein:
the granular perpendicular magnetic recording layer is from about 5 to about 30 nm thick and comprised of a Co-based alloy wherein segregation of magnetic grains occurs via formation of oxides, nitrides, or carbides at the boundaries between adjacent grains.

14. The apparatus of claim 11, wherein:
the continuous perpendicular magnetic recording layer is from about 2 to about 15 nm thick and comprised of one or more layers of a Co-based alloy.

15. The apparatus of claim 11, wherein:
the layer stack further comprises at least one interlayer between said multilayer perpendicular magnetic recording structure and said SUL.

16. A recording device, comprising:
magnetic layers including a magnetically hard perpendicular layer, wherein the layers having a magnetic thickness of up to about 2 memu/cm̂2.

17. The recording device of claim 16, wherein:
the magnetic layers include a plurality of overlying thin film layers forming a layer stack on a substrate surface, the layer stack including the magnetically hard perpendicular layer structure and an underlying soft magnetic underlayer (SUL).

18. The recording device of claim 17, wherein:
the layer stack further comprises an Ru-containing material interlayer between the magnetically hard perpendicular layer and said SUL, and wherein the Ru-containing material comprises RuX, where X is B or Cr.

19. The recording device of claim 16, wherein:
the magnetically hard perpendicular layer structure comprises a granular perpendicular magnetic recording layer, wherein the magnetic grains are exchange coupled together, and
an overlying continuous perpendicular magnetic recording layer wherein the magnetic grains are exchange coupled laterally together, and the magnetic grains in the continuous perpendicular layer are more strongly exchange coupled than the magnetic grains in the granular perpendicular magnetic recording layer.

20. The recording device of claim 16, wherein:
the granular perpendicular magnetic recording layer and the continuous perpendicular magnetic recording layer are ferromagnetically coupled together to form a coupled granular-continuous (CGC) structure.

21. The recording device of claim 16, wherein:
the granular perpendicular magnetic recording layer is from about 5 to about 30 nm thick and comprised of a Co-based alloy wherein segregation of magnetic grains occurs via formation of oxides, nitrides, or carbides at the boundaries between adjacent grains.
